(19) United States
(12) Patent Application Publication
(10) Pub. No.: US 2019/0373828 A1
(43) Pub. Date: Dec. 12, 2019

(54) Flow through Oxygen Infuser

(71) Applicant: Robert Scott Elkington, Mill Valley, CA (US)

(72) Inventor: Robert Scott Elkington, Mill Valley, CA (US)

(21) Appl. No.: 16/004,378

(22) Filed: Jun. 9, 2018

(51) Int. Cl. A01G 31/02; A01G 27/00; A01G 25/16

(52) U.S. Cl. CPC A01G 31/02; A01G 2031/006; A01G 25/16; A01G 27/008

(57) ABSTRACT

A flow-through oxygen infuser which is an assemblage of one or more venturis, in a chamber, is disclosed. When a venturi(s) is placed in an airtight chamber and water is passed through the venturi(s) a negative pressure is formed in the airtight chamber; additionally a minimal amount of pure oxygen is injected into the chamber generating very small bubbles of oxygen in the water passing through the venturis. The very small oxygen bubbles remain in suspension forming a solution supersaturated in oxygen. A flow-through model for infusing water with oxygen is disclosed. The use of supersaturated water for enhancing the growth of plants is disclosed. Methods for applying supersaturated water to plants in hydroponic culture are described. The promotion of beneficial aerobic bacteria with supersaturated water is described.

### BACKGROUND OF THE INVENTION

The first objective of this invention was to make a simple super-saturator. All that is required is a water pump, a bottle of oxygen, an oxygen regulator and or gas rotameter.

Many benefits are achieved through raising the oxygen content of aqueous media. Efforts to achieve higher saturated or supersaturated oxygen levels for applications, such as hydroponic culture, biological culture (aerobic bacteria) in cell cultures, and where the respiring cells would benefit from higher oxygen content of the medium are discussed.

The most common method of increasing the oxygen content of a medium is by sparging with air through an air stone (also known as an aquarium bubbler). While this is a simple method, the results never reach an oxygen level past the saturation point (see table 1). Attempts to use pure oxygen with air stones have resulted in failure do the large bubbles produced and the large amount of oxygen consumed, as high as 7 liters per minute per air stone. The Oxygen Infuser makes small bubbles and consumes a minimal amount of pure oxygen, to infuse a large amount of water.

When infusing water with oxygen the size of the bubble makes a difference. If a single large bubble and 8 small bubbles have the same total amount of oxygen inside of them, then the surface area of the smaller bubbles will always be greater. Consider this example: a bubble with a 5 mm diameter has a volume of 524 mm³ and a surface area of 314 mm². A bubble with a 10 mm diameter has a volume of 4,188 mm³ and a surface area of 1,256 mm². The 10 mm bubble could be divided into eight 5 mm bubbles, which would have a combined surface area of 2,512 mm³. By producing bubbles that are half the size, the surface area is effectively doubled, multiplying the surface contact of bubbles to water therefore doubling the capacity of the oxygen to increase the DO (dissolved oxygen) level. Additionally, smaller bubbles are less buoyant and rise through the water slower allowing them to diffuse more oxygen into the water. https://www.instructables.com/id/Mini-Hydroponic-aeration-tower/ Shows a device for oxygenating water, it consists of 4 venturis, in a pipe, but without a chamber or pure oxygen supply, no supersaturation can be effected.

U.S. D734639S1 Shows a multi venturi wine aerator, but without a chamber or pure oxygen supply no super saturation can be effected.

One other method to supersaturate water with oxygen is to use electricity such as described in U.S. Pat. Nos. 7,396,441-7,670,495-6,689,262-8,157,972. Some drawbacks to this method are potentially explosive gasses that can be released as a byproduct, and the risk of electric shock. For safety reasons, the use these devices around enclosures where animals are held is unadvisable.

Plant roots are healthier when oxygenated water is applied. Oxygen inhibits the growth of deleterious fungi, furthermore high oxygen concentrations in the grow media encourage nutrient uptake in plants. The water sparged with oxygen as in the U.S. Pat. No. 7,396,441 was shown to increase the biomass of organically grown peppers and tomatoes from, approximately, 13% to 32%.

### SUMMARY OF THE INVENTION

The present invention produces small bubbles of oxygen via the introduction of oxygen to water.

This invention provides an oxygen infuser, which is a cluster of one or more venturis in a chamber The chamber is supplied with a continuous restricted (restricted to allow a negative pressure to build in the chamber) flow of pure oxygen which generates very small bubbles of oxygen in an aqueous solution, resulting in a medium supersaturated with oxygen. The discharge height of the venturi chamber can be adjusted to produce maximum supersaturation results based on the gallons per minute flow of liquid through the device.

Models with any number and size of venturi(s) can be produced to be applicable to various volumes of aqueous medium to be oxygenated. Potential users are directed to choose the applicable model based on volume requirements of projected use. This invention includes a method to promote growth and increase yield of plants by application of superoxygenated water. The water treated with the infuser of this invention is one example of superoxygenated water. Plants may be grown in hydroponic culture or in soil. The use of the flow-through model for drip irrigation of crops and waste water treatment is disclosed.

The oxygen-containing gas used is preferably pure oxygen. The term “pure oxygen” herein means oxygen which has a minimum purity of approximately 80% by volume. For example, technical-grade oxygen which is produced by liquefying air and typically complies with the purity specification “oxygen 2.01” (minimum purity 99% by volume) or “oxygen 2.5” (minimum purity 99.5% by volume) can be used. Use of such technical-grade purity oxygen gases is possible if this permits an economic procedure to be achieved.

### Definitions: (as Used in this Document)

“Chamber” means container.

“Flow-Through Oxygen Infuser”, “Oxygen Infuser” means one or more flow-through venturi(s) in an airtight chamber with a supply of oxygen.

“Oxy-system” (“non-oxy”) means a system incorporating the oxygen infuser; “non-oxy” means system without use of oxygen infuser.

“ppm” means parts-per-million

“Supersaturated” means oxygen at a higher concentration than normal calculated oxygen solubility at a particular temperature and pressure.

“Superoxygenated water” means water with an oxygen content at least 120% of that calculated to be saturated at a temperature.

“Vacuum” means negative pressure.

“Venturi” means a tube with a tapering constriction in the middle.

“Water” means any aqueous medium.

### DESCRIPTION OF THE DRAWING

FIG. 1. Section view of the oxygen infuser: (1) water inlet; (2) inlet chamber; (3) venturis; (4) oxygen inlet; (5) airtight vacuum/oxygen chamber (6) discharge,

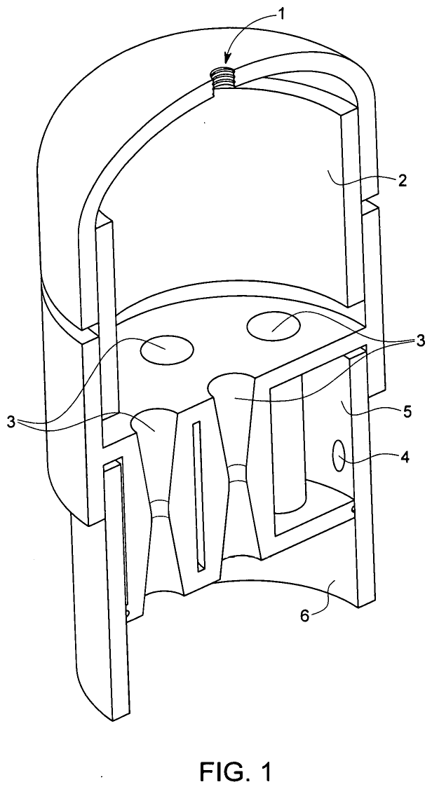

Water is supplied via (1) water inlet into the (2) inlet chamber, then to the venturi(s) (3), then discharges through the discharge chamber (6). Oxygen is introduced into the airtight vacuum oxygen chamber (5) via (4) the oxygen inlet.

### EXAMPLES OF PROCESS

### Example 1: Measurement of O₂ Bubbles

Attempts were made to measure the diameter of the O₂ bubbles emitted by the device of Example 1. In the case of particles other than gasses, measurements can easily be made by scanning electron microscopy, but gasses do not survive electron microscopy. Large bubble may be measured by pore exclusion, for example, which is also not feasible when measuring a gas bubble. Oxygen PPM measurements were made in with a Hach 146900 Dissolved Oxygen Test Kit, Model OX-2P. under various temperatures of water. See Table 1 below:

TABLE 1

| | | |
|---|---|---|
| 15.5° C. | 16 | ppm oxygen |
| 18.3° C. | 13 | ppm oxygen |
| 20° C. | 12 | ppm oxygen |
| 26.6° C. | 10 | ppm oxygen |

Maximum Naturally occurring Oxygen saturation
levels at zero percent Salinity:

| | | |
|---|---|---|
| 15.5° C. | 9.95 | ppm oxygen |
| 18.3° C. | 9.4 | ppm oxygen |
| 20° C. | 9.1 | ppm oxygen |
| 26.6° C. | 8.1 | ppm oxygen |

### Example 2: Design and Use of Venturi(s)

The venturi chamber of this invention may be shaped as a circle, rectangle, cone or other shape. One or more venturis may be placed in the airtight vacuum oxygen chamber.

### Example 3: Effect of Superoxygenated Water on the Growth of Plants

Oxygen is important for the growth of plants. Although plants produce oxygen as a byproduct during photosynthesis, they also have a requirement for oxygen to produce respiration. Oxygen is passed out through opened stomata of the plants. Often the roots of plants can be oxygen starved without enough to support optimum respiration, which can be reflected in less than optimum growth and nutrient utilization. Hydroponically grown plants are particularly susceptible to oxygen deficit in the root system.

### Example 4: Light Used in Hydroponic Culture with Oxygen Infuser

Many plants respond to superoxygenated water with tremendous growth using either artificial or natural light.

### Example 5: Field Study with Superoxygenated Water in Hydroponic System

A pilot study was implemented to show the benefit from the application of the oxygen infuser. Water treated with the oxygen infuser was used for one section of the hydroponic growing system while a separate section used air-borne oxygen only.

Seeds were planted in five-inch diameter net-pots and placed in a tray in a controlled environment hydroponic cabinet. All the plants sprouted after one week (May 1^{st}) On June 1^{st} plants were moved to a greenhouse with the oxy-system on one side and the non-oxy (same device but no supplied oxygen) on the other side. Plants were an average of 3 inches tall at this time. Oxygen measured 13 ppm in the oxy-system and 9 ppm in the non-o×y system. By August 25^{th} the oxygen infused plants were twice the size of the non-oxygen infused plants.

### PATENT CITATIONS (82)

https://www.instructables.com/id/Mini-Hydroponic-aeration-tower/

### Publication Number Priority Date Publication Date Assignee Title

U.S. Pat. No. 4,514,930A Method and apparatus for aeroponic propagation of plants
U.S. D614443S1 *2009 Apr. 27 2010 Apr. 27 William Federighi Pour spout with aerator
U.S. D652251S1 *2011 May 26 2012 Jan. 17 Sunbeam Products, Inc. Wine aerator
US20120156345A1 *2010 Dec. 20 2012 Jun. 21 Dhruv Agarwal Bottle top aerator
US20120156338A1 *2010 Dec. 20 2012 Jun. 21 Dhruv Agarwal Variably throttled beverage aerator
U.S. D677524S1 *2011 Dec. 20 2013 Mar. 12 Dhruv Agarwal Bottle top aerator
U.S. D681393S1 *2011 Dec. 20 2013 May 7 True Fabrications, Inc. Adjustable venturi aerator
US20130153685A1 *2011 Dec. 16 2013 Jun. 20 Drobot Michael J. Combination aerator, pourer, preserver, and stopper for a container
2013 Jan. 23 2013 Oct. 22 Brookstone Purchasing, Inc. Aeration system
U.S. D701080S1 *2012 Nov. 21 2014 Mar. 18 Brookstone Purchasing, Inc. Wine aerator
U.S. D702493S1 *2012 Nov. 10 2014 Apr. 15 Best Luck Technology Development Limited Wine aerator
US20140120226A1 *2012 Oct. 25 2014 May 1 Murat Kuru Interchangeable bottle top aerator
U.S. D705004S1 *2012 Nov. 21 2014 May 20 Brookstone Purchasing, Inc. Wine aerator
U.S. D710649S1 *2013 Apr. 24 2014 Aug. 12 Steven Kihl Wine aerator
US20140252662A1 *2013 Mar. 11 2014 Sep. 11 Craig William Graham Aeration Method
US20140284823A1 *2013 Mar. 22 2014 Sep. 25 Scott Fraser Aerator and method for aerating a liquid
U.S. D805841S1 *2016 May 3 2017 Dec. 26 Yevgeniy Khayman Wine aerator
U.S. D812421S1 *2016 Aug. 8 2018 Mar. 13 Linde Ag Wine aerator
U.S. D734639S1 *2014 Apr. 18 2015 Jul. 21 Skip A Lei Multi stream wine aerator
U.S. D719402S1 *2013 Jul. 5 2014 Dec. 16 Farhan Khan Wine chiller and aerator
U.S. D720959S1 *2012 Dec. 27 2015 Jan. 13 Sponti Limited Wine aerator and dispenser
US20120261844A1 *2011 Apr. 14 2012 Oct. 18 Lei Skip A Multi Stream Wine Aerating Device
U.S. Pat. No. 6,171,469B2*
U.S. Pat. No. 4,225,401A *1978 Dec. 22 1980 Sep. 30 Kernforschungsanlage Julich Gesellschaft Mit Beschrankter Haftung Method for generating hydrogen and oxygen
U.S. Pat. No. 4,252,856A 1973 Mar. 12 1981 Feb. 24 Union Carbide CorporationChemically bonded aluminum coated carbon via monocarbides
U.S. Pat. No. 4,587,001A *1983 Jun. 21 1986 May 6 Imperial Chemical Industries Plc Cathode for use in electrolytic cell
U.S. Pat. No. 5,015,354A *1988 May 11 1991 May 14 Permelec Electrode Ltd. Bipolar-electrode electrolytic cell
U.S. Pat. No. 5,534,143A 1990 Sep. 18 1996 Jul. 9 Louisiana State University Board Of Supervisors, A Governing Body Of Louisiana State University Agricultural And Mechanical CollegeMicrobubble generator for the transfer of oxygen to microbial inocula, and microbubble generator immobilized cell reactor
WO1999039561A1 1998 Feb. 10 1999 Aug. 12 Mazzei Angelo L Beneficiation of soil with dissolved oxygen for growing crops
U.S. Pat. No. 5,982,609A 1993 Mar. 22 1999 Nov. 9 Evans Capacitor Co., Inc. Capacitor
U.S. Pat. No. 6,171,469B1 *1996 Oct. 31 2001 Jan. 9 H2O Technologies, Ltd. Method and apparatus for increasing the oxygen content of water
U.S. Pat. No. 6,315,886B1 1998 Dec. 7 2001 Nov. 13 The Electrosynthesis Company, Inc. Electrolytic apparatus and methods for purification of aqueous solutions
U.S. Pat. No. 6,394,429B2 1996 May 13 2002 May 28 Universidad De Sevilla Device and method for fluid aeration via gas forced through a liquid within an orifice of a pressure chamber
US20020074237A1 *2000 Dec. 19 2002 Jun. 20 Tominaga Mfg. Co. Method of producing electrolyzed water
WO2003072507A1 2002 Feb. 22 2003 Sep. 4 Aqua Innovations, Inc. Microbubbles of oxygen Family To Family Citations
U.S. Pat. No. 1,677,153A *1926 Feb. 11 1928 Jul. 17 Charles H Spencer Method for treating soils to promote plant growth
U.S. Pat. No. 3,671,022A *1969 Oct. 6 1972 Jun. 20 Air Reduction Method and apparatus for the microdispersion of oxygen in water
U.S. Pat. No. 3,959,131A 1974 Oct. 17 1976 May 25 Swift & Company Apparatus and method for removing pollutants from wastewater
GB1531775A *1975 Apr. 16 1978 Nov. 8 Swift & CoGas flotation dewatering of waste water treatment wastes
U.S. Pat. No. 4,219,417A *1976 Dec. 21 1980 Aug. 26 Dravo Corporation Wastewater flotation utilizing streaming potential adjustment
U.S. Pat. No. 4,179,347A 1978 Feb. 28 1979 Dec. 18 Omnipure, Inc. System for electrocatalytic treatment of waste water streams
U.S. Pat. No. 4,257,352A *1979 Apr. 12 1981 Mar. 24 Ronald J. Randazza Protozoan marine life inhibitor
U.S. Pat. No. 4,732,661A *1985 Oct. 24 1988 Mar. 22 Mercer International, Inc. Electrolytic purification system
U.S. Pat. No. 5,049,252A *1986 Jan. 21 1991 Sep. 17 Murrell Wilfred A Water cleaning system
U.S. Pat. No. 5,275,732A *1990 Jul. 3 1994 Jan. 4 International Environmental Systems, Inc., UsaCombined coarse and fine bubble separation system
U.S. Pat. No. 5,148,772A *1991 Jan. 7 1992 Sep. 22 Kirschbaum Robert N Method and apparatus for electrically inhibiting bacteria growth in aquariums
JP3323217B2 *1991 Dec. 27 2002 Sep. 9 [symbol] Cleanup and activation device of water
U.S. Pat. No. 5,389,214A *1992 Jun. 19 1995 Feb. 14 Water Regeneration Systems, Inc. Fluid treatment system employing electrically reconfigurable electrode arrangement
KR960005828B1 *1992 Aug. 5 1996 May 1 [symbol] Process for preparation of pyridine derivatives
U.S. Pat. No. 5,561,944A *1992 Nov. 4 1996 Oct. 8 African Oxygen Limited Method and apparatus for enhancing the growth and quality of edible plants
U.S. Pat. No. 5,500,131A *1994 Apr. 5 1996 Mar. 19 Metz; Jean-Paul Compositions and methods for water treatment
EP0723936B1 1995 Jan. 30 1999 May 12 First Ocean Co., Ltd. A composite electrode construction for electrolysis of water
U.S. Pat. No. 5,697,187A *1995 Dec. 13 1997 Dec. 16 Oxlon, Inc. Method for treatment of crops by an irrigation solution
JPH09285230A *1996 Apr. 24 1997 Nov. 4 Fuaamaazu Design Kk Hydroponic apparatus
U.S. Pat. No. 5,728,287A 1996 Dec. 31 1998 Mar. 17 H2O Technologies, Ltd. Method and apparatus for generating oxygenated water
U.S. Pat. No. 5,911,870A 1997 Apr. 11 1999 Jun. 15 H2O Technologies, Ltd. Housing and method that provide extended resident time for dissolving generated oxygen into water
U.S. Pat. No. 7,128,278B2 *1997 Oct. 24 2006 Oct. 31 Microdiffusion, Inc. System and method for irritating with aerated water
U.S. Pat. No. 6,386,751B1 1997 Oct. 24 2002 May 14 Diffusion Dynamics, Inc. Diffuser/emulsifier
U.S. Pat. No. 6,126,794A *1998 Jun. 26 2000 Oct. 3 Xogen Power Inc. Apparatus for producing orthohydrogen and/or parahydrogen
U.S. Pat. No. 6,524,475B1 1999 May 25 2003 Feb. 25 Miox Corporation Portable water disinfection system
U.S. Pat. No. 6,243,987B1 *1999 Sep. 1 2001 Jun. 12 Organitech Ltd. Self contained fully automated robotic crop production facility
U.S. Pat. No. 6,296,756B1 *1999 Sep. 9 2001 Oct. 2 H2O Technologies, Ltd. Hand portable water purification system
WO2001089997A9 2000 May 11 2003 Jan. 23 Megaton Systems As Means for electrochemical treatment of water
U.S. Pat. No. 6,634,138B2 *2000 Dec. 28 2003 Oct. 21 Richard Jed Katzman Self-sustaining indoor waterfall planter
JP2003136067A *2001 Oct. 31 2003 May 13 Sanyo Electric Co Ltd Water treatment method and water treatment system
U.S. Pat. No. 7,396,441B2 *2002 Feb. 22 2008 Jul. 8 Aqua Innovations, Inc. Flow-through oxygenator
U.S. Pat. No. 6,890,126B2 *2002 Jul. 3 2005 May 10 Angelo L. Mazzei Subsurface water/air irrigation system with prevention of air lock
JP2004121962A *2002 Oct. 1 2004 Apr. 22 National Institute Of Advanced Industrial & Technology Method and apparatus for using nanometer-bubble
CN1780326A *2005 Jan. 5 2006 May 31 [symbol] ( [symbol] ) [symbol] Self-adaptive adjusting method for talk volume
U.S. Pat. No. 8,007,654B2 *2006 Feb. 10 2011 Aug. 30 Tennant Company Electrochemically activated anolyte and catholyte liquid
JP4168068B2 *2006 Sep. 25 2008 Oct. 22 [symbol] [symbol] Liquid containing micro-nano bubbles manufacturing method, liquid containing micro manufacturing apparatus, and liquid containing micro application device
US20090293357A1 *2008 May 27 2009 Dec. 3 Ross Vickers Aeroponic atomizer for horticulture
US20100218423A1 *2009 Feb. 27 2010 Sep. 2 Zack Allen Walhovd Aeroponic plant growing system
US20110023359A1 *2009 Jul. 29 2011 Feb. 3 David Raring Aeroponic growing apparatus and method
US20110061296A1 *2009 Sep. 11 2011 Mar. 17 Robert Scott Simmons Apparatus for aeroponically growing and developing plants
US20110061297A1 *2009 Sep. 11 2011 Mar. 17 Simmons Robert S Apparatus for aeroponically growing and developing plants
US20120144740A1 *2010 Dec. 9 2012 Jun. 14 Pure-Grow, Inc., PURE-Grown totally concealed clean room vegetable factory
US20130019527A1 *2011 Jul. 21 2013 Jan. 24 Ingrid Howe-Sylvain Mobile, Automatic Plant Growth System
U.S. Pat. No. 8,505,238B2 2011 May 25 2013 Aug. 13 Terry Luebbers Vertical aeroponic plant growing system
US20140083007A1 *2012 Sep. 24 2014 Mar. 27 Rocquel S. Galvan Spiral garden
US20140338261A1 *2013 May 14 2014 Nov. 20 Chad Colin Sykes Modular aeroponic system and related methods
U.S. Pat. No. 8,904,705B2 2010 Jul. 7 2014 Dec. 9 Thomas J. Downs, S R. Aeroponic system and sprayer device for improved plant growth and aeration
US20150313103A1 *2013 Feb. 6 2015 Nov. 5 Panasonic Intellectual Property Management Co., Ltd. Hydroponics apparatus and hydroponics method

WO2016133804A1 *2015 Feb. 18 2016 Aug. 25 Fogworks LLC Soilless plant growing systems

What is claimed:

1. An oxygen infuser comprised of a container with one or more tubes with a tapering constriction in the middle, passing through it (venturi/s).
